(19) United States
(12) Patent Application Publication
(10) Pub. No.: US 2013/0257589 A1
(43) Pub. Date: Oct. 3, 2013

(54) ACCESS CONTROL USING AN ELECTRONIC LOCK EMPLOYING SHORT RANGE COMMUNICATION WITH MOBILE DEVICE

(71) Applicants: Mohammad Mohiuddin, Boynton Beach, FL (US); Stewart E. Hall, Wellington, FL (US)

(72) Inventors: Mohammad Mohiuddin, Boynton Beach, FL (US); Stewart E. Hall, Wellington, FL (US)

(21) Appl. No.: 13/782,476

(22) Filed: Mar. 1, 2013

Related U.S. Application Data
(60) Provisional application No. 61/617,417, filed on Mar. 29, 2012.

(51) Int. Cl. G08C 17/02

(52) U.S. Cl. CPC G08C 17/02
USPC 340/5.61

(57) ABSTRACT

Systems and methods for obtaining access to an area or an object secured by an electronic locking device. The methods involve: obtaining, by a Mobile Communication Device (“MCD”), a unique identifier associated with the Electronic Locking Device (“ELD”)via a first Short Range Communication (“SRC”); communicating the unique identifier from MCD to a Remote Communication Device (“RCD”) via a network connection; receiving at least one symbol associated with the unique identifier that facilitates unlocking of ELD from RCD via the network connection; and causing ELD to be unlocked by communicating a key from MCD to ELD via a second SRC.

### CROSS REFERENCE TO RELATED APPLICATIONS

This application claims the benefit of U.S. Provisional Patent Application Ser. No. 61/617,417, filed Mar. 29, 2012, which is herein incorporated by reference.

### FIELD OF THE INVENTION

This document relates generally to systems and methods for using mobile communication devices in an access control system. More particularly, this document relates to systems and methods for obtaining access to a secured area AND/or object using an electronic lock and mobile device employing short range communication technology (e.g., Near Field Communication (“NFC”) technology and/or barcode technology) and/or mobile technology.

### BACKGROUND OF THE INVENTION

Access control systems are used to prevent unwanted entry into a physical area and/or unwanted access to an object or item. In a typical system, access is granted using an identity devices (e.g., a smart card) which interacts with an access control device (e.g., a smart card reader). The access control device is networked to an access control database. Access is granted or denied by comparing identity data obtained by the access control device with credential information stored in the database.

An NFC is a short-range wireless communication between devices over a relatively small distance (e.g., N centimeters or N inches, where N is an integer such as twelve). The NFC may be established by touching devices together or bringing them into close proximity such that an inductive coupling occurs between inductive circuits thereof. In some scenarios, the NFC operates at 13.56 MHz and at rates ranging from 106 kbit/s to 848 kbit/s. The NFC may be achieved using NFC transceivers configured to enable contactless communication at 13.56 MHz. NFC transceivers are well known in the art, and therefore will not be described in detail herein.

Today, mobile communication devices include NFC chips. For example, mobile communication devices, operating on a Global System for Mobile (“GSM”) communication network, include a Subscriber Identification Module (“SIM”) having remotely-accessible secure memory space. This secure memory space is used for e-commerce transactions. New applications using NFC protocols can utilize this secure memory space to enable the mobile device to perform functions in a manner similar to that of a smart card. The ability to have a mobile device also operate as a smart card creates a variety of new applications for the device, such as the ability to act as an electronic key used with NFC-enabled electronic locking devices.

Existing NFC electronic locking systems rely on a central credential database and require that the person seeking access be pre-enrolled in the system. Currently, these NFC electronic locking systems typically require network connection to the central credential database which works in conjunction with secondary authentication devices, such as a key pad or a finger print reader, to perform controlled locking/unlocking function.

A disadvantage of using these types of NFC-enabled electronic locking systems is that they require a great deal of system infrastructure to be in place which must be centrally administered. The current systems may require installation of dedicated reader/interrogator devices, such as card readers, keypads, finger print readers or other biometric devices. The existing systems must also rely on a network connection to a central database, and also require central database management. For example, if a person requires access to a secured location, his/her credentials have to be added to the database and either a PIN has to be assigned to the person or finger prints have to be added to the database prior to using the system. On-the-go access will require first adding and then deactivation/removing credentials from the database which can be a time consuming process.

### SUMMARY OF THE INVENTION

The present invention concerns implementing systems and methods for obtaining access to an area or an object secured by an electronic locking device. The methods involve obtaining, by a mobile communication device (e.g., a Smartphone), a unique identifier associated with the electronic locking device via a first short range communication (e.g., a near field communication or a barcode communication). The unique identifier is then communicated from the mobile communication device to a remote communication device (e.g., a computing device or a smartphone) via a network connection (e.g., an RF connection and/or an Internet connection). The network connection can be an unsecure connection or a secure connection. The unique identifier is used by the remote communication device to obtain at least one symbol associated with the unique identifier that facilitates unlocking of the electronic locking device. The symbol may comprise a key or a code from which the key can be derived or generated. The symbol is then communicated from the remote communication device to the mobile communication device via the network connection. If the symbol comprises the code, then the mobile communication device may derive or generate the key using the code. Thereafter, the key is communicated from the mobile communication device to the electronic locking device via a second short range communication (e.g., a near field communication). Upon receipt of the key, the electronic locking device is caused to be unlocked.

In some scenarios, instructions are also communicated from the mobile communication device to the electronic locking device via the second short range communications. The instructions are configured to cause the key to be used only once during a defined period of time to unlock the electronic locking device.

When a user of the mobile communication device no longer needs access to the area or object, a locking code is communicated from the mobile communication device to the electronic locking device via a third short range communication (e.g., a near field communication). The locking code is configured to cause the locking of the electronic locking device. Subsequently, a message is received from the electronic locking device via a fourth short range communication (e.g., a near field communication) indicating that the electronic locking device has been locked. The message may then be forwarded from the mobile communication device to the remote communication device via the network connection.

The present invention also concerns other systems and methods for obtaining access to an area or an object secured by an electronic locking device. These methods involve obtaining, by a mobile communication device, a unique identifier associated with the electronic locking device via a first short range communication. The unique identifier and authentication information is then communicated from the mobile communication device to a cloud network. Operations are performed by the cloud network to authenticate a user of the mobile communication device using the authentication information. When the user is authenticated, an unlocking command is sent from the cloud network to the electronic locking device.

The present invention also concerns other systems and methods for obtaining access to an area or an object secured by an electronic locking device. These methods involve receiving, by a mobile communication device, a unique identifier associated with the electronic locking device via a first short range communication. In response to the reception of the unique identifier, an automated call is placed to a remote telephone. Thereafter, a code for unlocking the electronic locking device is received from the remote telephone. The code is communicated from the mobile communication device to the electronic locking device via a second short range communication, thereby causing the electronic locking device to be unlocked.

### BRIEF DESCRIPTION OF THE DRAWINGS

FIG. 1 is a schematic illustration of an example of a system configured to control access to a geographic area or an object via NFC-based data exchange, barcode technology and/or mobile technology.

FIG. 2 is a schematic illustration of an exemplary architecture for a service provider electronic locking device which is NFC-enabled.

FIG. 3 is a schematic illustration of an exemplary architecture for a mobile communication device which is NFC-enabled.

FIG. 4 is a flow diagram of an exemplary method for registering service provider electronic locking devices with a service provider system.

FIGS. 5A-5E provide a flow diagram of an exemplary method for unlocking and locking an electronic lock mechanism.

FIG. 6 is a schematic illustration of another exemplary system configured to control access to a geographic area or an object via NFC-based data exchange, barcode technology and/or mobile technology.

FIG. 7 is a flow diagram of another exemplary method for unlocking and locking an electronic lock mechanism.

FIG. 8 is a schematic illustration of yet another exemplary system configured to control access to a geographic area or an object via NFC-based data exchange and/or mobile technology.

FIGS. 9A-9C provide a flow diagram of yet another exemplary method for unlocking and locking an electronic lock mechanism.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

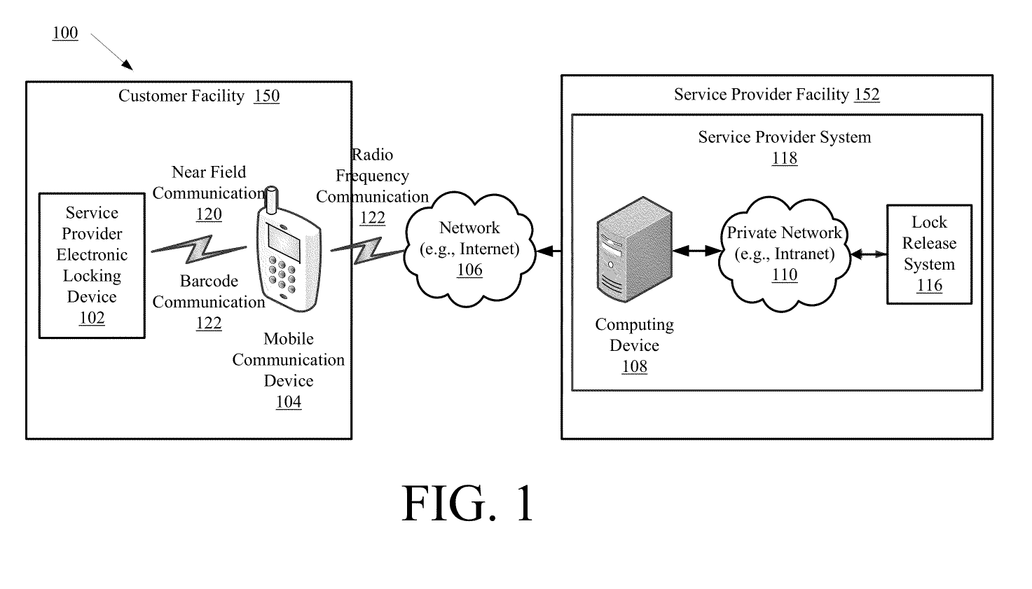

Embodiments will now be described with respect to FIGS. 1-9C. Embodiments generally relate to systems and methods for providing novel solutions to obtaining access to a secured area or a secured object. Such access is achieved through an exchange of data between a computing system (e.g., a Smartphone) and a remotely located non-connected electronic locking devices. The term “non-connected electronic locking device”, as used herein with respect to a given computing system, refers to an electronic locking device that is absent of a network interface and/or that is not connected to a given computing system via a network connection, and therefore is not network accessible to the given computing system. This does not necessarily mean that the electronic locking device is devoid of any network connection but rather that it has no network connection to a given computing system, such as that of a service provider facility. The electronic locking device can include, but is not limited to, a door lock, a display cabinet lock, and/or a security lock or tag for a consumer product (e.g., clothing).

The novel solutions generally employ short range communication technology and/or mobile technology to facilitate the data exchange between the computing system and the remotely located non-connected electronic locking device. The short range communication technology can include, but is not limited to, NFC technology and/or barcode technology. The particularities of how such technologies facilitate the provision of improved access control solutions will become evident as the discussion progresses. As a consequence of employing such technologies, the novel solutions are less costly as compared to conventional network connected electronic locking solutions.

Notably, the novel systems and methods are discussed herein in relation to retail applications. Embodiments of the present invention are not limited in this regard. The novel systems and methods can be used in a plurality of different applications. All that is necessary is that data must be obtained by a service provider from an electronic locking device that is not network accessible to the service provider. As such, the novel systems and methods can additionally or alternatively be used in geographic area access control applications, vehicle/machinery access control applications, vending machine applications, parking meter applications, and any other application where access to an area, object and/or item is protected by an electronic locking device.

Referring now to FIG. 1, there is provided a schematic illustration of a system 100. The system 100 is generally configured to provide data exchange between computing systems and remotely located non-connected electronic locking devices via short range communication technology and/or mobile technology. The short range communication technology can include, but is not limited to, NFC technology and barcode technology. In this regard, the system 100 comprises a Service Provider System (“SPS”) 118 and a Service Provider Electronic Locking Device (“SPELD”) 102 which are configured to facilitate the provision of various services to a customer. Such services include, but are not limited to, access control services to geographic areas and/or objects.

As shown in FIG. 1, the SPELD 102 is disposed in a customer facility 150 (e.g., a retail store), while the SPS 118 is disposed in a facility 152 of a Service Provider (“SP”) that is remote from the customer facility 150. The invention is not limited in this regard. For example, both the SPELD 102 and SPS 118 can be located within the customer facility 150. In both scenarios, the SPS 118 comprises a computing device 108 of a person with authority to grant access to secure areas and/or objects via the SPELD 102. In some scenarios, the computing device 108 includes, but is not limited to, a desktop computer, a laptop computer, a tablet computer, a notebook computer, a person digital assistant, or a mobile phone with smart device functionality.

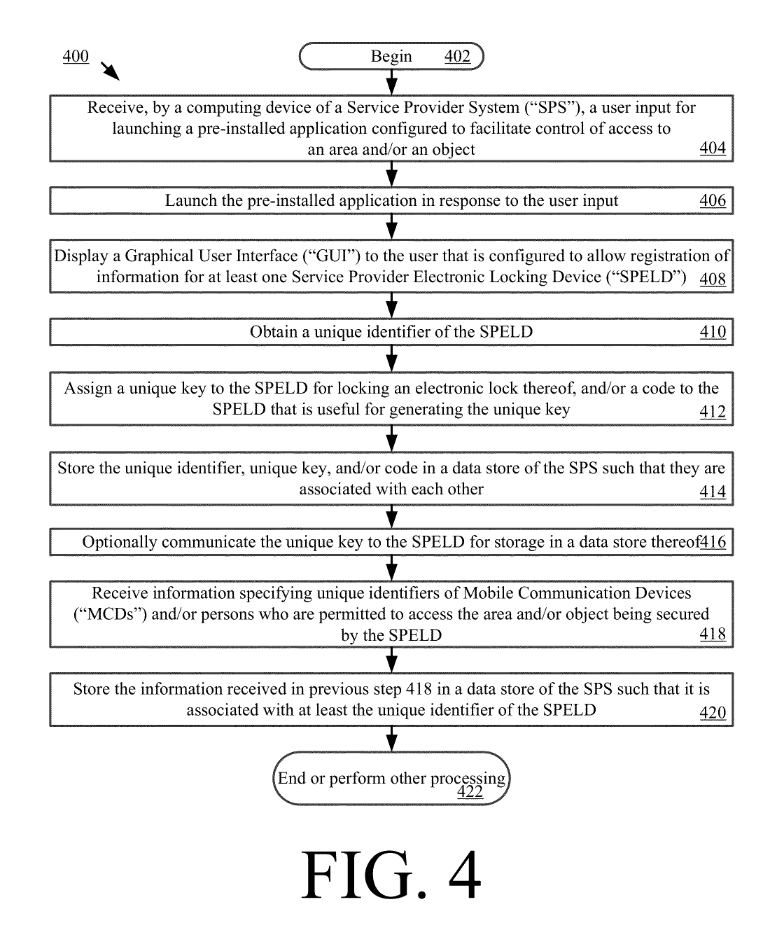

In the access control scenarios, the SPELD 102 can comprise a non-connected electronic locking device coupled to a door, a gate, a display case, a cabinet, and/or a consumer product (e.g., clothing). The non-connected electronic locking device is not directly communicatively connected to the SPS 118 via a network (e.g., the Internet). Therefore, the requisite information for unlocking and/or relocking the electronic lock can not be communicated automatically between the SPELD 102 and the SPS 118 via a communications link established therebetween over the network 106. However, the system 100 is designed to allow data exchange between the SPELD 102 and the SPS 118 despite the lack of network connection of the SPELD 102. In this regard, the system 100 implements novel methods for providing data exchange between components 102, 118 thereof. Such novel methods will be described below in relation to FIGS. 4-9C. Still, it should be understood that the novel methods generally employ NFC technology, barcode technology and/or mobile technology to enable data exchanges between components 102, 118. Accordingly, the non-connected electronic locking device of the SPELD 102 is NFC-enabled or is coupled to an NFC-enabled device. The non-connected electronic locking device and/or NFC-enabled device can have a barcode attached to an exposed surface thereof. The term “barcode”, as used herein, refers to a pattern or symbol that contains embedded data. Barcodes may include, for example, one-dimensional barcodes, two dimensional barcodes (such as matrix codes, Quick Response (“QR”) codes, Aztec codes and the like), or three-dimensional bar codes. The embedded data can include, but is not limited to, a unique identifier of the SPELD 102 and/or area/object being secured by the SPELD 102.

During an access control process, the SPELD 102 exchanges data with a Mobile Communication Device (“MCD”) 104 via an NFC 120 and/or a barcode communication 122. This data can include, but is not limited to, the unique identifier of the SPELD 102 and/or area/object being secured by the SPELD 102. Barcode and near field communications 122, 120 are well known in the art, and therefore will not be described in detail herein. Still, it should be understood that a barcode communication is achieved using a barcode and a barcode scanner/reader. Barcode scanners/readers are well known in the art. Any known or to be known barcode scanner/reader can be used herein without limitation. An NFC is a short-range wireless communication between devices over a relatively small distance (e.g., N centimeters or N inches, where N is an integer such as twelve). The NFC may be established by touching devices 102, 104 together or bringing them into close proximity such that an inductive coupling occurs between inductive circuits thereof. In some scenarios, the NFC operates at 13.56 MHz and at rates ranging from 106 kbit/s to 848 kbit/s. The NFC may be achieved using NFC transceivers configured to enable contactless communication at 13.56 MHz. NFC transceivers are well known in the art, and therefore will not be described in detail herein. Any known or to be known NFC transceiver can be used herein without limitation.

The present invention is not limited to NFC and barcode communications between devices 102, 104. Additionally or alternatively, devices 102, 104 can exchange information via other protocols. Such other protocols include, but are not limited to, Bluetooth, 2.4 GHz frequency, Global System for Mobile (“GSM”) communication frequency, General Packet Radio Services (“GPRS”) frequency, Code Division Multiple Access (“CDMA”) frequencies, and/or WiFi.

Referring again to FIG. 1, the MCD 104 comprises a portable computing device of a person who wants access to an area and/or an object that is being secured by the SPELD 102. In some scenarios, the MCD 104 includes, but is not limited to, a desktop computer, a laptop computer, a tablet computer, a notebook computer, a person digital assistant, or a mobile phone with smart device functionality. The MCD 104 may be operative to authenticate a user prior to allowing a user to initiate a process for unlocking the electronic lock mechanism of the SPELD 102.

After obtaining the unique identifier(s) from the SPELD 102, the MCD 104 communicates the same to the SPS 118 via a network 106 (e.g., the Internet or a mobile phone network) and RF communications 122. In turn, the SPS 118 may communicate a response message to the MCD 104 via network 106 and RF communications 122. The response message can include a key, a code, time limit information and/or information specifying the number of times a key can be used, as described in more detail below. RF and network communications are well known in the art, and therefore will not be described in detail herein. Notably, the communications between components 104, 118 may be secure communications in which cryptography is employed. In such scenarios, a cryptographic key can also be communicated from the MCD 104 to the SPS 118, or vice versa. The cryptographic key can be a single use cryptographic key.

At the SPS 118, the unique identifier(s) may be processed for various reasons. In this regard, the unique identifier(s) may be received at computing device 108 of the SPS 118 and forwarded thereby to a sub-system via a private network 110 (e.g., an Intranet). For example, the unique identifier(s) can be forwarded to and processed by a lock release sub-system 116 to retrieve a key or a code that is useful for opening the electronic lock of the SPELD 102. In this regard, the lock release sub-system 116 can comprise a data store in which keys and/or codes are stored in association with unique identifiers for a plurality of SPELDs, respectively. Each key can include, but is not limited to, at least one symbol selected for unlocking/locking a respective electronic lock. In some scenarios, the unique key can be a “one-time-only” use key in which it enables the unlocking of an electronic lock only once during a given period of time (e.g., N days, N weeks, N months, or N years, where N is an integer equal to or greater than 1). Each code can include, but is not limited to, at least one symbol from which a unique key can be derived. The unique key can be derived from the code by the SPS 118 or the MCD 104. The unique key and/or code can be stored in a secure manner within the SPS 118 and/or the MCD 104, as will be discussed below. In the case that the key is generated by the MCD 104, the key generation operations are performed in a secure manner. For example, the algorithm for generating the key can be performed by a processor with a tamper-proof enclosure, such that if a person maliciously attempts to extract the algorithm from the processor the algorithm will be erased prior to any unauthorized access thereto.

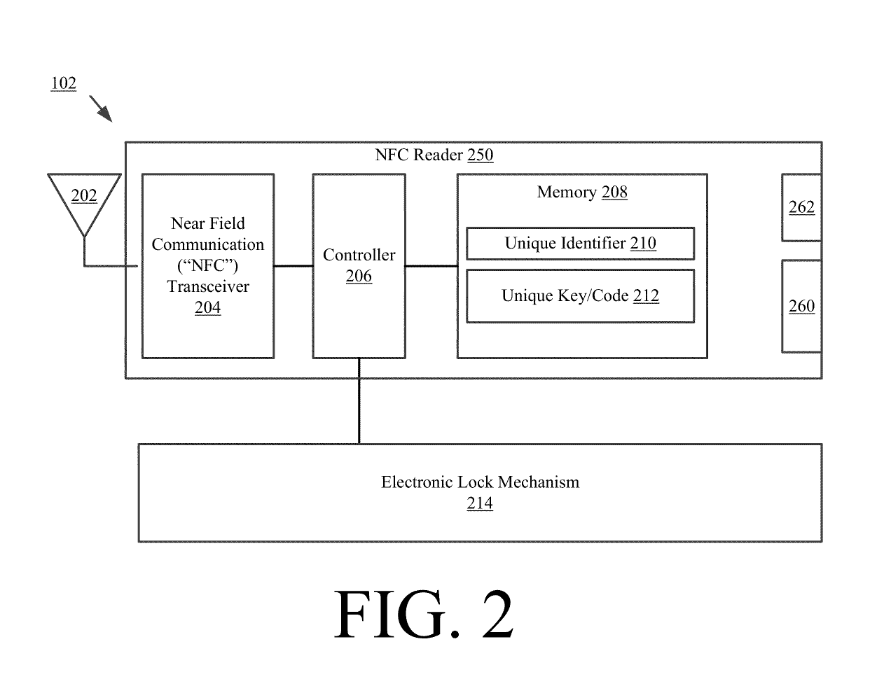

Referring now to FIG. 2, there is provided a more detailed block diagram of one embodiment of an SPELD 102. SPELD 102 may include more or less components than those shown in FIG. 2. However, the components shown are sufficient to disclose an illustrative embodiment implementing the present invention. Some or all of the components of the SPELD 102 can be implemented as hardware, software and/or a combination of hardware and software. The hardware includes, but is not limited to, one or more electronic circuits.

The hardware architecture of FIG. 2 represents one embodiment of a representative SPELD 102 configured to facilitate the control of access to an area and/or object. In this regard, the SPELD 102 may have a barcode 262 affixed thereto for allowing data to be exchanged between the SPELD 102 and an external device (e.g., MCD 104 of FIG. 1) via barcode technology. The SPELD 102 also includes an antenna 202 and an NFC transceiver 204 for allowing data to be exchanged between the SPELD 102 and the external device (e.g., MCD 104 of FIG. 1) via NFC technology. The antenna 202 is configured to receive and transmit NFC signals. NFC transceivers are well known in the art, and therefore will not be described in detail herein. However, it should be understood that the NFC transceiver 204 processes received NFC signals to extract information therein. This information can include, but is not limited to, a request for certain information (e.g., a unique identifier 210), and/or a message including information specifying a key or code for locking or unlocking an electronic lock mechanism 216. The NFC transceiver 204 may pass the extracted information to the controller 206.

If the extracted information includes a request for certain information, then the controller 206 may perform operations to retrieve a unique identifier 210 from memory 208. The unique identifier 210 is then sent from the SPELD 102 to a requesting external device (e.g., MCD 104 of FIG. 1) via an NFC communication (e.g., NFC 120 of FIG. 1).

In contrast, if the extracted information includes information specifying a “one-time-only” use key and/or instructions for programming the SPELD to unlock the electronic lock mechanism 214 using the “one-time-only” use key, then the controller 206 may perform operations to simply unlock an electronic lock mechanism 214 using the “one-time-only” use key. Alternatively or additionally, the controller 206 can: parse the information from a received message; retrieve a unique key/code 212 from memory 208; and compare the parsed information to the unique key/code 212 to determine if a match exists therebetween. If a match exists, then the controller 206 generates and sends a command to the electronic lock mechanism 214 for locking or unlocking the same. If a match does not exist, then the controller 206 may generate a response message indicating that the unique key/code specified in the extracted information does not match the unique key/code 212 stored in memory 208. The response message may then be sent from the SPELD 102 to a requesting external device (e.g., MCD 104 of FIG. 1) via an NFC communication (e.g., NFC 120 of FIG. 1). A message may also be communicated to another external device or network node via a system interface 260.

In some scenarios, the connections between components 206, 208, 214 are unsecure connections or secure connections. The phrase “unsecure connection”, as used herein, refers to a connection in which cryptography and/or tamper-proof measures are not employed. The phrase “secure connection”, as used herein, refers to a connection in which cryptography and/or tamper-proof measures are employed. Such tamper-proof measures include enclosing the physical electrical link between two components in a tamper-proof enclosure.

Notably, the memory 208 may be a volatile memory and/or a non-volatile memory. For example, the memory 208 can include, but is not limited to, a Random Access Memory (“RAM”), a Dynamic Random Access Memory (“DRAM”), a Static Random Access Memory (“SRAM”), a Read-Only Memory (“ROM”) and a flash memory. The memory 208 may also comprise unsecure memory and/or secure memory. The phrase “unsecure memory”, as used herein, refers to memory configured to store data in a plain text form. The phrase “secure memory”, as used herein, refers to memory configured to store data in an encrypted form and/or memory having or being disposed in a secure or tamper-proof enclosure.

The electronic lock mechanism 214 is operable to actuate a mechanical structure to move a lock between a locked state and an unlocked state. The electronic lock mechanism 214 is shown in FIG. 2 as being indirectly coupled to the NFC transceiver 204 via controller 206. The invention is not limited in this regard. The electronic lock mechanism 214 can additionally or alternatively be directly coupled to the NFC transceiver 204. One or more of the components 204, 206 can cause the lock to be transitioned between states in accordance with information received from an external device (e.g., MCD 104 of FIG. 1). The components 204-208 may collectively be referred to herein as an NFC reader 250.

The NFC reader 250 can be incorporated into a device which also houses the electronic lock mechanism 214, or can be a separate device which is in direct or indirect communication with the electronic lock mechanism 214. The NFC reader 250 is coupled to a power source (not shown in FIG. 2). The power source may include, but is not limited to, a battery or an A/C power connection. Alternatively or additionally, the NFC reader 250 is configured as a passive device which derives power from an RF signal inductively coupled thereto.

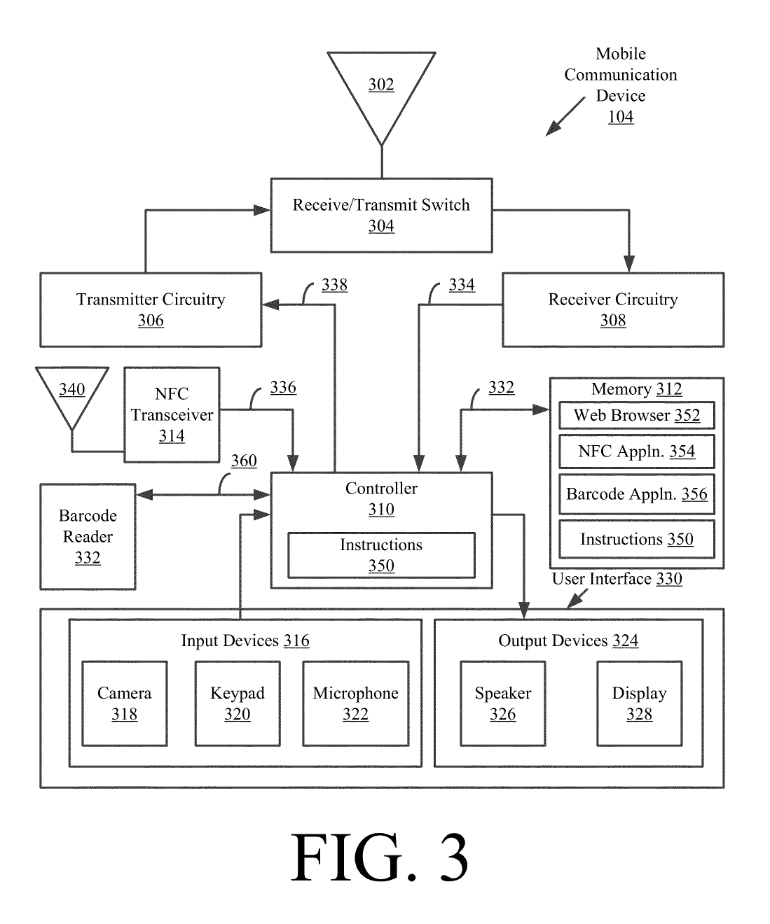

Referring now to FIG. 3, there is provided a more detailed block diagram of one embodiment of an MCD 104. MCD 104 may include more or less components than those shown in FIG. 3. However, the components shown are sufficient to disclose an illustrative embodiment implementing the present invention. Some or all of the components of the MCD 104 can be implemented as hardware, software and/or a combination of hardware and software. The hardware includes, but is not limited to, one or more electronic circuits.

The hardware architecture of FIG. 3 represents one embodiment of a representative MCD 104 configured to facilitate the data exchange between an SPELD (e.g., SPELD 102 of FIG. 1) and an SPS (e.g., SPS 118 of FIG. 1) via NFC technology, barcode technology and/or mobile technology. In this regard, MCD 104 comprises an antenna 302 for receiving and transmitting RF signals. A receive/transmit (“Rx/Tx”) switch 304 selectively couples the antenna 302 to the transmitter circuitry 306 and receiver circuitry 308 in a manner familiar to those skilled in the art. The receiver circuitry 308 demodulates and decodes the RF signals received from a network (e.g., the network 106 of FIG. 1). The receiver circuitry 308 is coupled to a controller (or microprocessor) 310 via an electrical connection 334. The receiver circuitry 308 provides the decoded signal information to the controller 310. The controller 310 uses the decoded RF signal information in accordance with the function(s) of the MCD 104.

The controller 310 also provides information to the transmitter circuitry 306 for encoding and modulating information into RF signals. Accordingly, the controller 310 is coupled to the transmitter circuitry 306 via an electrical connection 338. The transmitter circuitry 306 communicates the RF signals to the antenna 302 for transmission to an external device (e.g., a node of a network 106 of FIG. 1) via the Rx/Tx switch 304.

An antenna 340 may be coupled to an NFC transceiver 314 for receiving NFC signals. NFC transceivers are well known in the art, and therefore will not be described in detail herein. However, it should be understood that the NFC transceiver 314 processes the NFC signals to extract information therefrom. The NFC transceiver 314 may process the NFC signals in a manner defined by the NFC application 354 installed on the MCD 104. The NFC application 354 can include, but is not limited to, a Commercial Off The Shelf (“COTS”) application. The NFC transceiver 314 provides the extracted information to the controller 310. As such, the NFC transceiver 314 is coupled to the controller 310 via an electrical connection 336. The controller 310 uses the extracted information in accordance with the function(s) of the MCD 104. For example, the extracted information can be used by the MCD 104 to generate a request for a key or code associated with a particular SPELD 102 from an SPS (e.g., SPS 118 of FIG. 1). Thereafter, the MCD 104 sends the request to the SPS via transmit circuitry 306 and antenna 302.

The controller 310 may store received and extracted information in memory 312 of the MCD 104. Accordingly, the memory 312 is connected to and accessible by the controller 310 through electrical connection 332. The memory 312 may be a volatile memory and/or a non-volatile memory. For example, the memory 312 can include, but is not limited to, a RAM, a DRAM, an SRAM, a ROM and a flash memory. The memory 312 may also comprise unsecure memory and/or secure memory. The memory 212 can be used to store various other types of information therein, such as authentication information, cryptographic information, location information and various service-related information.

The MCD 104 also may comprise a barcode reader 332. Barcode readers are well known in the art, and therefore will not be described herein. However, it should be understood that the barcode reader 332 is generally configured to scan a barcode and process the scanned barcode to extract information therefrom. The barcode reader 332 may process the barcode in a manner defined by the barcode application 356 installed on the MCD 104. Additionally, the barcode scanning application can use the MCD camera to capture the barcode image for processing. The barcode application 356 can include, but is not limited to, a COTS application. The barcode reader 332 provides the extracted information to the controller 310. As such, the barcode reader 332 is coupled to the controller 310 via an electrical connection 360. The controller 310 uses the extracted information in accordance with the function(s) of the MCD 104. MCD 104 may be used as a pass-through for information between an SPELD (e.g., SPELD 102 of FIG. 1) and a service provider system (e.g., service provider system 118 of FIG. 1).

As shown in FIG. 3, one or more sets of instructions 350 are stored in memory 312. The instructions 350 may include customizable instructions and non-customizable instructions. The instructions 350 can also reside, completely or at least partially, within the controller 310 during execution thereof by MCD 104. In this regard, the memory 312 and the controller 310 can constitute machine-readable media. The term “machine-readable media”, as used here, refers to a single medium or multiple media that stores one or more sets of instructions 350. The term “machine-readable media”, as used here, also refers to any medium that is capable of storing, encoding or carrying the set of instructions 350 for execution by the MCD 104 and that causes the MCD 104 to perform one or more of the methodologies of the present disclosure.

The controller 310 is also connected to a user interface 330. The user interface 330 comprises input devices 316, output devices 324 and software routines (not shown in FIG. 3) configured to allow a user to interact with and control software applications (e.g., application software 352-356 and other software applications) installed on the MCD 104. Such input and output devices may include, but are not limited to, a display 328, a speaker 326, a keypad 320, a directional pad (not shown in FIG. 3), a directional knob (not shown in FIG. 3), a microphone 322 and a camera 318. The display 328 may be designed to accept touch screen inputs. As such, user interface 330 can facilitate a user-software interaction for launching applications (e.g., application software 352-356) installed on MCD 104. The user interface 330 can facilitate a user-software interactive session for writing data to and reading data from memory 312.

The display 328, keypad 320, directional pad (not shown in FIG. 3) and directional knob (not shown in FIG. 3) can collectively provide a user with a means to initiate one or more software applications or functions of the MCD 104. The application software 354-356 can facilitate the data exchange between an SPELD (e.g., SPELD 102 of FIG. 1) and an SPS (e.g., SPS 118 of FIG. 1). In this regard, the application software 354-356 performs one or more of the following: verify an identity of a user of the MCD 104 via an authentication process; present information to the user indicating that her/his identity has been or has not been verified; and present a Graphical User Interface (“GUI”) to the user for enabling the user to initiate a process for locking or unlocking an electronic lock of the SPELD (e.g., SPELD 102 of FIG. 1). This process can generally involve: obtaining a unique identifier (e.g., unique identifier 210 of FIG. 2) from the SPELD (e.g., SPELD 102 of FIG. 1); forwarding the unique identifier to the SPS (e.g., SPS 118 of FIG. 1); receiving a message from the SPS that includes information specifying a unique key or a code associated with unique identifier; optionally deriving the unique key from the code; optionally generating instructions for programming the SPELD to unlock an electronic lock mechanism using the unique on a one-time basis; and sending the unique key and/or instructions to the SPELD (e.g., SPELD 102 of FIG. 1).

Referring now to FIG. 4, there is provided a flow diagram of an exemplary method 400 for registering SPELDs (e.g., SPELD 102 of FIG. 1) with an SPS (e.g., SPS 118 of FIG. 1). The method 400 begins with step 402 and continues with step 404. In step 404, a computing device (e.g., computing device 108 of FIG. 1) of an SPS (e.g., SPS 118 of FIG. 1) receives a user input for launching a pre-installed application and/or an add-on application. The pre-installed application and/or add-on application is generally configured to facilitate control of access to an area and/or an object. The application can be downloaded to the computing device via a website or other electronic data transfer means prior to step 402. In some scenarios, the computing device comprises a mobile phone employing smart technology, barcode technology and/or NFC technology. Such a mobile phone is the same as or similar to that described above in relation to FIG. 3.

In response to the user input, the computing device launches the pre-installed application and/or add-on application, as shown by step 406. As a consequence of launching the pre-installed application and/or add-on application, a GUI is displayed on a display screen of the computing device in step 408. The GUI is generally configured to allow registration of information for at least one SPELD (e.g., SPELD 102 of FIG. 1).

In a next step 410, the computing device obtains a unique identifier (e.g., unique identifier 210 of FIG. 2) of the SPELD. The unique identifier can be obtained using barcode technology, NFC technology and/or via manual input by a user of the computing device. In the barcode scenario, the computing device obtains the unique identifier from a barcode affixed to the SPELD via a barcode reader. In the NFC scenario, the computing device obtains the unique identifier from the SPELD via NFC communications therewith. For example, the computing device is placed within proximity of the NFC transceiver (e.g., NFC transceiver 204 of FIG. 2) of the SPELD. Consequently, a uni-directional or a bi-directional communication is established between the computing device and the SPELD such that the unique identifier is provided to the computing device.

Subsequent to obtaining the unique identifier, at least one unique key and/or code is assigned to the SPELD as shown by step 412. This assignment can be automatically achieved or manually achieved. In the automatic assignment scenario, the computing device may generate the unique key(s) and/or code(s). Alternatively or additionally, the computing device may obtain the unique key(s) and/or code(s) from another computing device (e.g., a local computer or a remote server) via a wired or wireless link. The unique key may enable the unlocking and/or locking of an electronic lock mechanism (e.g., electronic lock mechanism 214 of FIG. 2) of the SPELD. The code may enable the generation of a key for unlocking the electronic lock mechanism and/or may enable the locking of the electronic lock mechanism. The key and/or code are then stored in a data store of the SPS such that they are associated with the unique identifier of the SPELD, as shown by step 414. The unique identifier, key(s) and/or code(s) can be stored in an unsecure manner or a secure manner depending on a particular application. In the secure storage scenario, the data can be stored in an encrypted form and/or in a data store with a tamper-proof enclosure.

In a next optional step 416, the key(s) and/or code(s) is(are) communicated to the SPELD for storage in a data store (e.g., memory 208 of FIG. 2) thereof. This communication can be achieved using NFC technology and/or via manual input. The key(s) and/or code(s) can be stored in an unsecure manner or a secure manner depending on a particular application. In the secure storage scenario, the data can be stored in an encrypted form and/or in a data store with a tamper-proof enclosure.

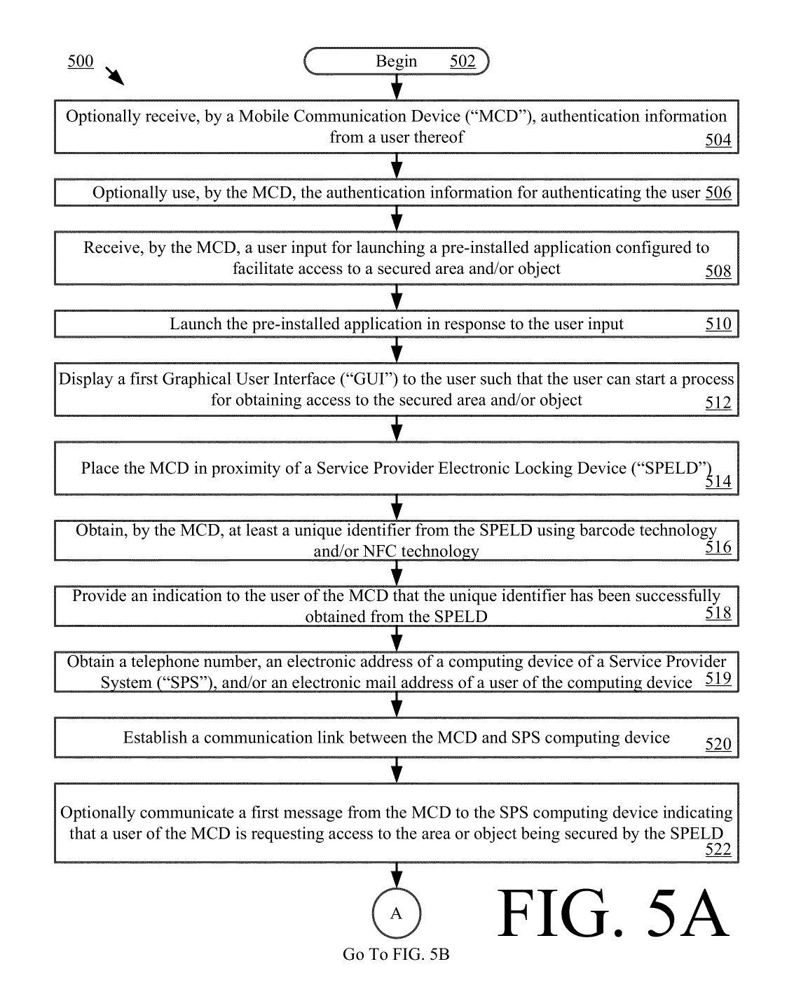

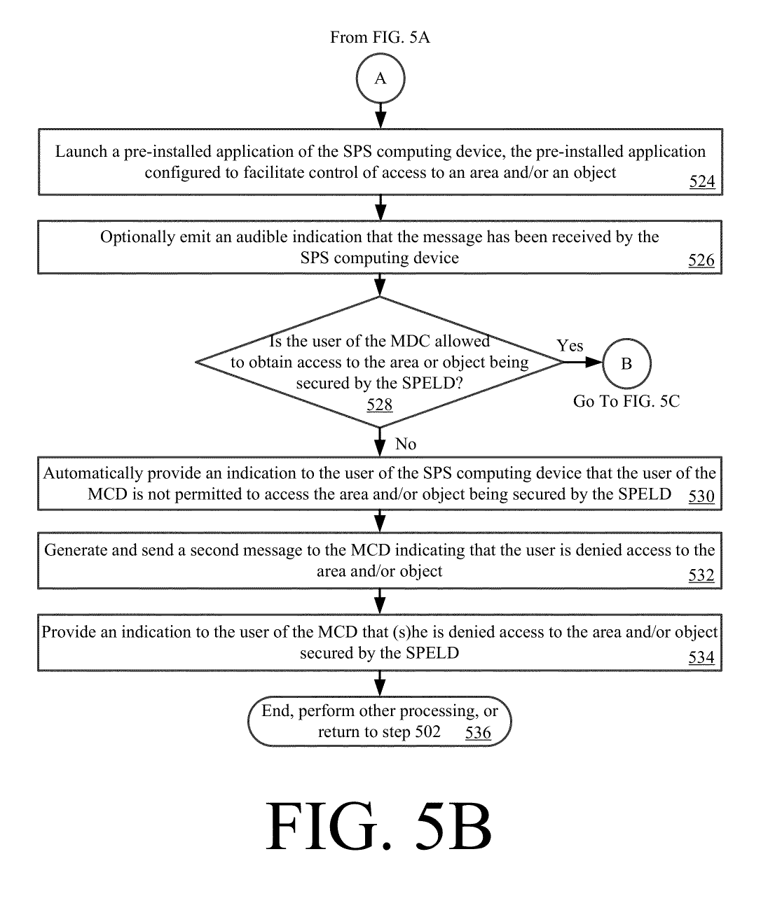

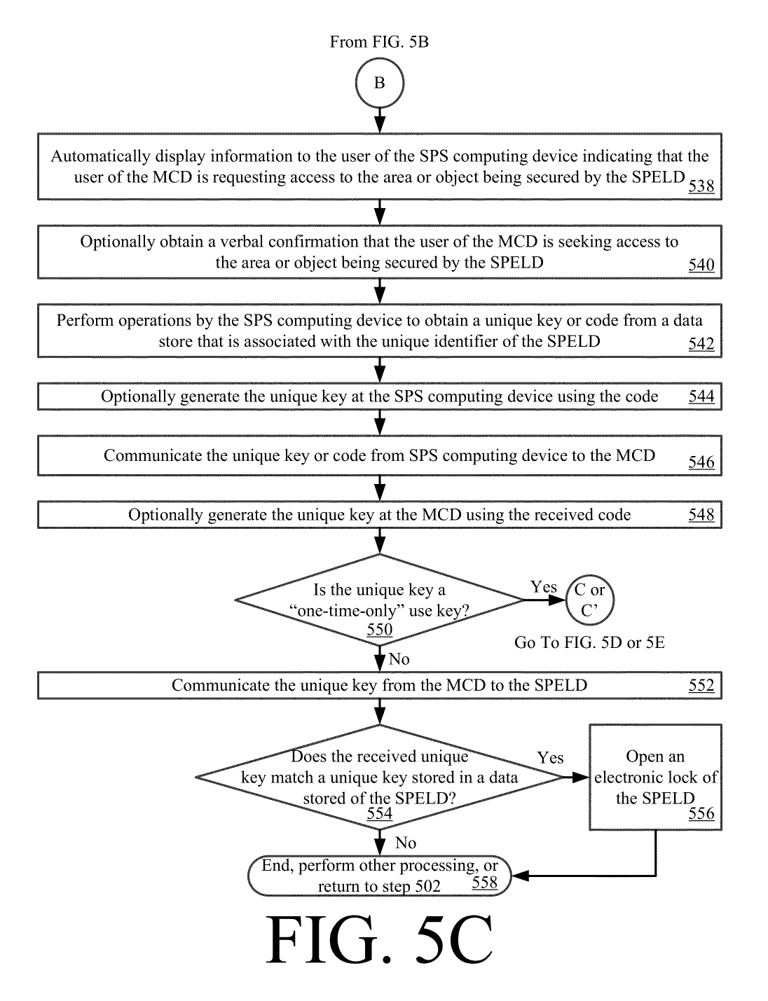

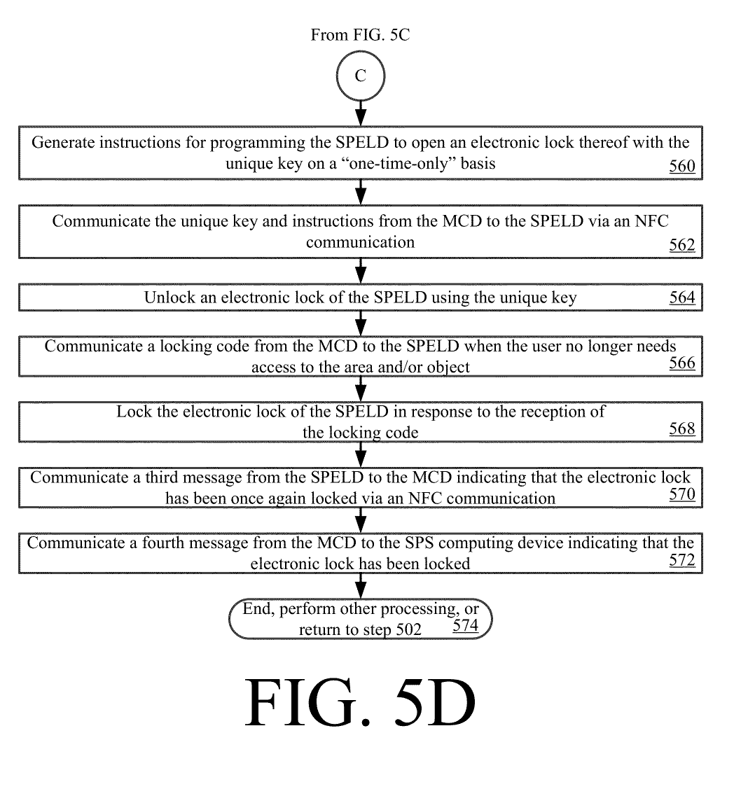

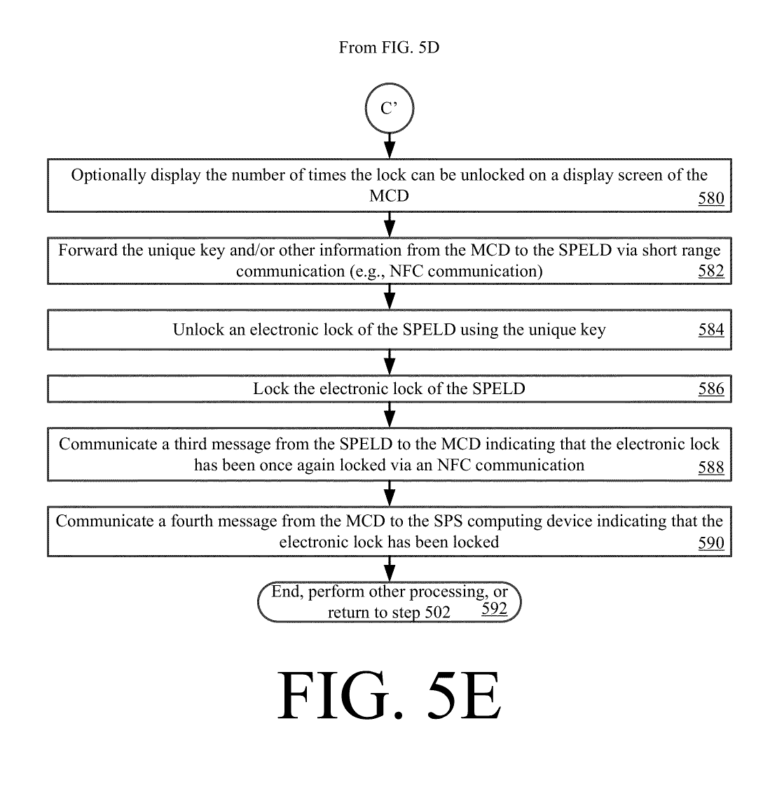

Thereafter, in step 418, the computing device receives information specifying unique identifiers of MCDs (e.g., MCDs 104 of FIG. 1) and/or persons who are permitted to access the area and/or object being secured by the SPELD. This information is then stored in a data store of the SPS such that it is associated with at least the unique identifier of the SPELD, as shown by step 420. In this regard, the unique identifiers of the SPELD and MCDs can be stored in a table format. Subsequently, step 422 is performed where the method 400 ends or other processing is performed. This other processing can include those of an exemplary method described below in relation to FIGS. 5A-9C.

Referring now to FIGS. 5A-5E, there is provided a flow diagram of an exemplary method 500 for unlocking and locking an electronic lock mechanism (e.g., electronic lock mechanism 214 of FIG. 2). As shown in FIG. 5A, the method 500 begins with step 502 and continues with an optional step 504. In optional step 504, an MCD (e.g., MCD 104 of FIG. 1) receives authentication information (e.g., a user name, a password, or biometric information) from a user thereof. The authentication information is used in a next step 506 for authenticating the user. Methods for authenticating users based on authentication information are well known in the art. Any known or to be known method for authenticating a user can be used herein without limitation.

After authenticating the user, step 508 is performed where the MCD receives a user input for launching a pre-installed application and/or add-on application configured to facilitate access to a secured area and/or object. The application can be downloaded to the MCD via a website or other electronic data transfer means prior to step 508. In response to the user input, the pre-installed application and/or add-on application is launched in step 510. In some scenarios, the pre-installed application and/or add-on application can be alternatively launched automatically in response to user authentication. Accordingly, method 500 can be absent of step 508.

As shown in FIG. 5A, the method 500 continues with step 512 where a first GUI is displayed to the user of the MCD. The first GUI enables the user to start a process for obtaining access to the secured area and/or object. Once the process has been initialized, the user places the MCD in proximity of an SPELD (e.g., SPELD 102 of FIG. 1). Next in step 516, the MCD obtains at least a unique identifier from the SPELD using barcode technology and/or NFC technology. An indication is provided to the user of the MCD that the unique identifier has been successfully received from the SPELD, as shown by step 518.

Subsequent to completing step 518, step 519 is performed where the MCD obtains a telephone number, an electronic address (e.g., an Internet Protocol (“IP”) address) of a computing device (e.g., computing device 108 of FIG. 1) of an SPS (e.g., SPS 118 of FIG. 1), and/or an electronic mail address of the user of the SPS computing device. The telephone number, electronic address and/or electronic mail address can be obtained from the user of the MCD or from a directory stored in a data store (e.g., memory 312 of FIG. 3) of the MCD.

The telephone number or the electronic address is then used in step 520 to establish a communication link between the MCD and SPS computing device. The communication link can include, but is not limited to, an RF communication link (e.g., RF communication link 122 of FIG. 1). In some scenarios, the MCD and/or the SPS computing device comprise a mobile phone employing smart technology.

Additionally or alternatively, step 520 can involve sending electronic mail to the user of the SPS computing device indicating that an access request has been made. In this scenario, the electronic mail may include, but is not limited to, a means for launching an application for granting/denying the access request, a unique identifier of the SPELD, a unique identifier of the object/item being secured by the SPELD, a unique identifier of the user of the MCD (e.g., a user name), and/or a unique identifier of the MCD (e.g., a telephone number).

Upon completing step 520, optional step 522 is performed. Optional step 522 can be performed if a communication link was established between the MCD and SPS computing device in step 520 via the telephone number or electronic address. Optional step 522 may not be performed where electronic mail is employed in step 520.

In optional step 522, a first message is communicated from the MCD to the SPS computing device. The first message may indicate that a user of the MCD is requesting access to the area and/or object being secured by the SPELD. In this regard, the message can include, but is not limited to, a unique identifier of the SPELD, a unique identifier of the object/item being secured by the SPELD, a unique identifier of the user of the MCD (e.g., a user name), and/or a unique identifier of the MCD (e.g., a telephone number). In some scenarios, the first message is a text message or a pre-recorded voice message. Thereafter, the method 500 continues with step 524 of FIG. 5B.

As shown in FIG. 5B, step 524 involves launching a pre-installed application and/or add-on application of the SPS computing device. The application can be launched in response to receiving the first message from the MCD or the electronic mail message from the MCD. The pre-installed application and/or add-on application can be automatically launched in response to the reception of the first message or electronic mail message. Alternatively, the pre-installed application and/or add-on application can be launched in response to a user-software interaction. The pre-installed application and/or add-on application is configured to facilitate control of access to the area and/or object. An audible indication may also optionally be emitted from the SPS computing device in response to the reception of the first message or electronic mail thereat, as shown by step 526.

Next, an optional decision step 528 is performed to determine if a user of the MCD is allowed to obtain access to the area and/or object being secured by the SPELD. This determination can be made using the information contained in the received message (i.e., the first message or the electronic mail message) and/or information stored in a data store of the SPS. For example, it may be determined that the user of the MCD is allowed to access the area and/or object when an identifier of the user and/or MCD match that stored in the data store of the SPS. Alternatively or additionally, such a determination can be made when a classification level assigned to the user is the same as that of the area or object being secured by the SPELD. The classification level can include, but is not limited to, a retail floor personnel, a retail store manager, a retail store owner, a secret level, a top secret level, a classified level, and/or an unclassified level.

If it is determined that the user of the MCD is not allowed access to the area and/or object being secured by the SPELD [528:N0], then steps 530-536 are performed. Step 530 involves automatically providing an indication to the user of the SPS computing device that the user of the MCD is not permitted to access the area and/or object being secured by the SPELD. Also, a second message is generated and sent to the MCD indicating that the user thereof is denied access to the area and/or object, as shown by step 532. Upon receipt of the second message at the MCD, an indication is provided to the user thereof that s(he) has been denied access to the area and/or object secured by the SPELD. Subsequently, step 536 is performed where the method 500 ends, other processing is performed, or the method 500 returns to step 502.

If it is determined that the user of the MCD is allowed access to the area and/or object being secured by the SPELD [528:YES], then step 538 of FIG. 5C is performed. As shown in FIG. 5C, step 538 involves automatically displaying information to the user of the SPS computing device which indicates that the user of the MCD is requesting access to the area and/or object being secured by the SPELD. In this regard, the displayed information can include, but is not limited to, information identifying the user of the MCD, information identifying the MCD, contact information for the user and/or MCD, and/or information identifying the area and/or object for which access is being requested. Thereafter, an optional step 540 is performed for obtaining a verbal confirmation from the user of the MCD that (s)he is seeking access to the area and/or object.

In a next step 542, the SPS computing device performs operations to obtain a unique key or code from a data store that is associated with the unique identifier of the SPELD. If a code is obtained in step 542, then an optional step 544 may be performed where the unique key is generated by the SPS computing device. In a next step 546, the unique key or code is communicated from the SPS computing device to the MCD. If the MCD receives the code, then it may generate the unique key using the code, as shown by optional step 548.

Once the MCD possesses the unique key, a decision is made in optional step 550 to determine if the unique key is a “one-time-only” use key. If it is determined that the unique key is not a “one-time-only” use key [550:N0], then steps 552-558 are performed. Step 552 involves communicating the unique key from the MCD to the SPELD. At the SPELD a decision is made as to whether the received unique key matches a unique key (e.g., unique key 212 of FIG. 2) stored in a data store (e.g., memory 208 of FIG. 2) thereof. If the received unique key matches the stored unique key [554:YES], then the electronic lock of the SPELD is opened using the unique key. Thereafter, step 558 is performed. In step 558 other processing may be performed. The other processing can involve performing steps 566-572 of FIG. 5D or steps 580-592 of FIG. 5E, which will be described below. If the received unique key does not match the stored unique key [554:N0], then step 558 is performed. In step 558, the method 500 ends, other processing is performed, or the method 500 returns to step 502.

If it is determined that the unique key is a “one-time-only” use key [550:YES], then the method 500 continues with steps 560-574 of FIG. 5D or steps 580-592 of FIG. 5E, depending on the particular application. As shown in FIG. 5D, step 560 involves generating instructions for programming the SPELD to open an electronic lock thereof with the unique key on a “one-time-only” basis. The unique key and the instructions are then sent in step 562 from the MCD to the SPELD via an NFC communication (e.g., NFC communication 120 of FIG. 1). Upon receipt of the unique key and instructions, the SPELD unlocks the electronic lock thereof, as shown by step 564. When the user of the MCD no longer needs access to the area and/or object, a locking code is communicated from the MCD to the SPELD, as shown by step 566. The locking code can be sent in response to a user-software interaction. In response to the reception of the locking code, the SPELD locks the electronic lock in step 568. A third message is then sent in step 570 from the SPELD to the MCD indicating that the electronic lock has been once again locked. The third message can be sent via an NFC communication (e.g., NFC communication 120 of FIG. 1). The third message can include, but is not limited to, a modified identifier, a sequence of symbols indicating that the lock has been locked, and/or a timestamp. Also, a fourth message is sent in step 572 from the MCD to the SPS computing device indicating that the electronic lock has been locked. Subsequently, step 574 is performed where the method 500 ends, other processing is performed, or the method 500 returns to step 502.

As shown in FIG. 5E, step 580 involves optionally displaying the number of times the lock can be unlocked using the unique key on a display screen of the MCD. In a next step 582, the MCD simply forwards the information received from SPS to SPELD without modification. The information can include, but is not limited to, a key/code for unlocking a lock, time out information, and/or information specifying the number of times the key/code can be used. The information can be sent in one or more transmissions from the MCD to the SPELD. At the SPELD, the key/code will be extracted from the information and used to cause the lock to be unlocked, as shown by step 584. When the user of the MCD no longer needs access to the area and/or object, the electronic lock is once again locked by the SPELD, as shown by step 586. In this regard, it should be understood that another read of the unique identifier of the SPELD by the MCD can trigger the start of a locking process. Additionally or alternatively, the electronic lock can be secured automatically when the time expires as specified by the time limit information received from the SPS via the MCD. Also, a timeout mechanism of the SPELD can start after a predetermined time period programmed in the SPELD has expired.

Once the electronic lock has been locked, a third message is then sent in step 588 from the SPELD to the MCD indicating that the electronic lock has been once again locked. The third message can be sent via an NFC communication (e.g., NFC communication 120 of FIG. 1). The third message can include, but is not limited to, a modified identifier, a sequence of symbols indicating that the lock has been locked, and/or a timestamp. Also, a fourth message is sent in step 590 from the MCD to the SPS computing device indicating that the electronic lock has been locked. Subsequently, step 592 is performed where the method 500 ends, other processing is performed, or the method 500 returns to step 502.

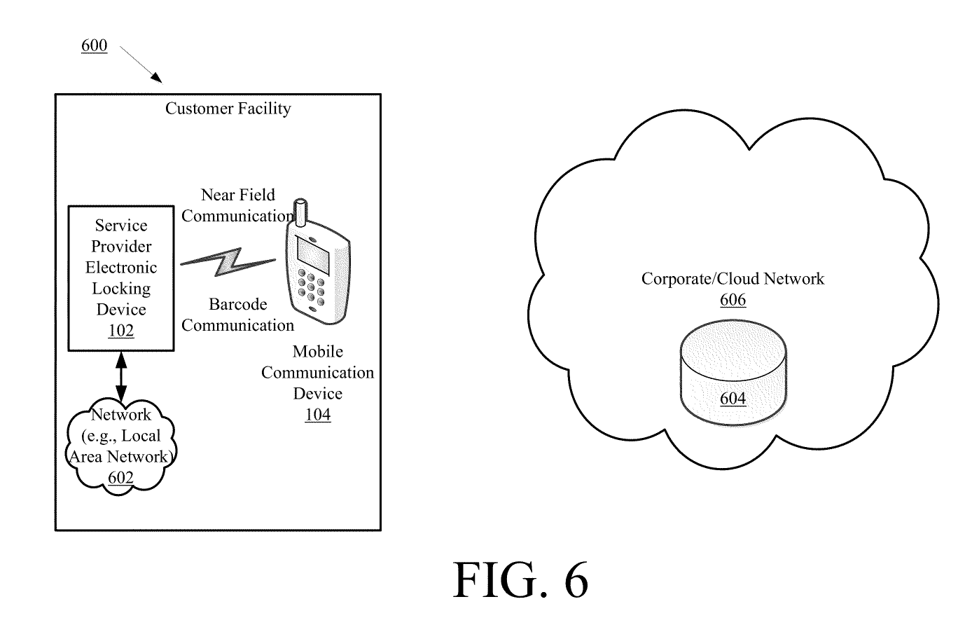

Referring now to FIG. 6, there is provided a schematic illustration of another exemplary system 600 in which the present invention can be implemented. As shown in FIG. 6, system 600 comprises SPS 102, MCD 104, and networks 602, 606. Network 606 is a corporate/cloud network that maintains a database 604 of unique keys and codes associated with SPELDs. The database 604 can also contain credential data and classification levels for individuals, such as customers and/or employees. As in the previous system 100, the SPELD 102 secures an area and/or an object. In this regard, the SPELD 102 comprises an electronic lock mechanism (e.g., electronic lock mechanism 214 of FIG. 2) and an NFC transceiver (e.g., NFC transceiver 204 of FIG. 2). The SPELD 102 may also comprise a network communication interface (e.g., system interface 260 of FIG. 2) coupling it to network 602. Network 602 can include, but is not limited to, a Local Area Network (“LAN”) or a Wide Area Network (“WAN”). Network 602 can be in communication with the corporate/cloud network 606, or otherwise can be the same network as the corporate/cloud network 606.

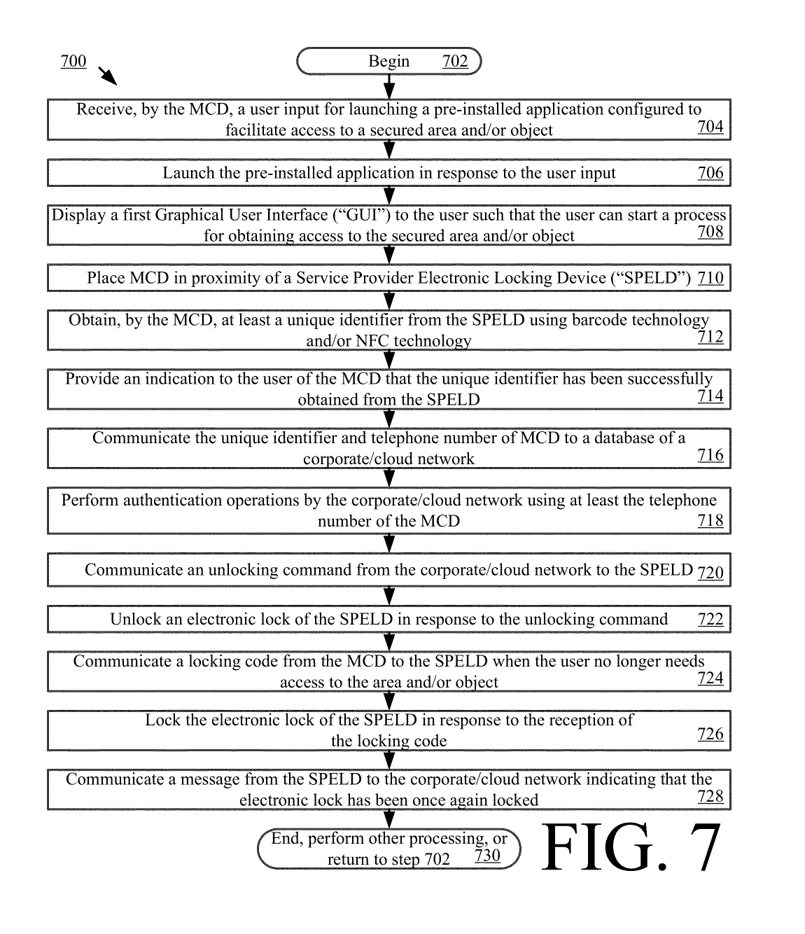

Referring now to FIG. 7, there is provided another exemplary method 700 for unlocking and locking an electronic lock mechanism (e.g., electronic lock mechanism 214 of FIG. 2). Method 700 can be implemented by system 600. As shown in FIG. 7, the method 700 begins with step 702 and continues with step 704. Step 704 involves receiving by an MCD (e.g., MCD 104 of FIG. 6) a user input for launching a pre-installed application and/or add-on application configured to facilitate access to a secured area and/or object. In response to the user input, the pre-installed application and/or add-on application is launched in step 706. In step 708, a first GUI is displayed to the user of the MCD such that the user can start a process for obtaining access to the secured area and/or object.

Next in step 710, the user places the MCD in proximity of an SPELD (e.g., SPELD 102 of FIG. 6). Consequently, a bi-directional communication is established between the SPELD and MCD. Using barcode or NFC technology, the MCD obtains an unique identifier from the SPELD, as shown by step 712. In step 714, the user of the MCD is provided with an indication that the unique identifier has been successfully obtained from the SPELD. The unique identifier is then sent in step 716 to a database (e.g., database 604 of FIG. 6) of a corporate/cloud network (e.g., corporate/cloud network 606 of FIG. 6).

At the corporate/cloud network, authentication operations are performed in step 718 to authenticate the user of the MCD using at least the telephone number of the MCD. Step 718 can also involve determining if the user of the MCD has the requisite permission to access the area and/or object being secured by the SPELD. Such a determination can be made based on the unique identifier, the telephone number and/or classification information associated with the user of the MCD and/or the area/object being secured by the SPELD. Once the authentication operations are complete, step 720 is performed where an unlocking command is sent from the corporate/cloud network to the SPELD. In response to the unlocking command, the SPELD unlocks an electronic lock thereof, as shown by step 722.

When the user of the MCD no longer needs access to the area and/or object, the MCD sends a locking code in step 724 to the SPELD. Thereafter, the SPELD lock the electronic lock in step 726. A message is then sent in step 728 from the SPELD to the corporate/cloud network indicating that the electronic lock has been once again locked. Upon completing step 728, step 730 is performed where the method 700 ends, other processing is performed, or the method 700 returns to step 702.

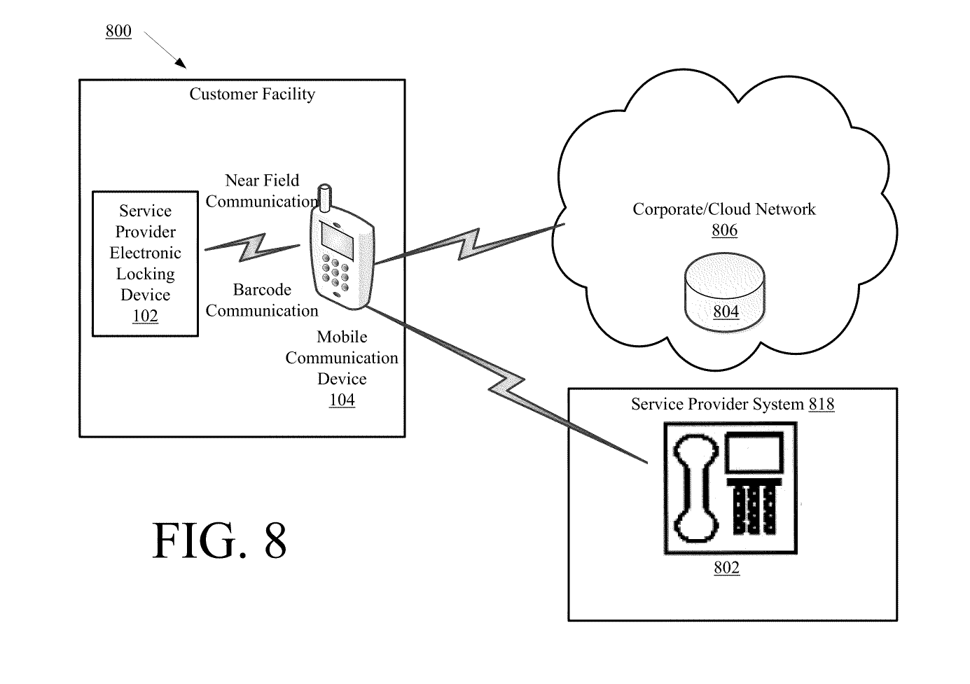

Referring now to FIG. 8, there is provided a schematic illustration of yet another exemplary system 800 configured to control access to a geographic area or an object via NFC-based data exchange and/or mobile technology. As shown in FIG. 8, the system 800 comprises an SPELD 102, an MCD 104, a telephone 802, and a corporate/cloud network 606. As in the previous system 100, the SPELD 102 secures an area and/or an object. In this regard, the SPELD 102 comprises an electronic lock mechanism (e.g., electronic lock mechanism 214 of FIG. 2) and an NFC transceiver (e.g., NFC transceiver 204 of FIG. 2). The MCD 104 is utilized by a person requesting access to secured areas and/or objects. The MCD 104 can include, but is not limited to, a mobile phone with smart technology. The telephone 802 is utilized by a person with authority to grant access to secure areas and/or objects via the SPELD 102. The telephone 802 can include, but is not limited to, a cellular telephone or a land-line telephone. Network 606 is a corporate/cloud network that maintains a database 604 of secured locations, secured objects, and unique identifiers/keys/codes associated therewith. The database 604 can also contain credential data for individuals, such as customers and/or employees.

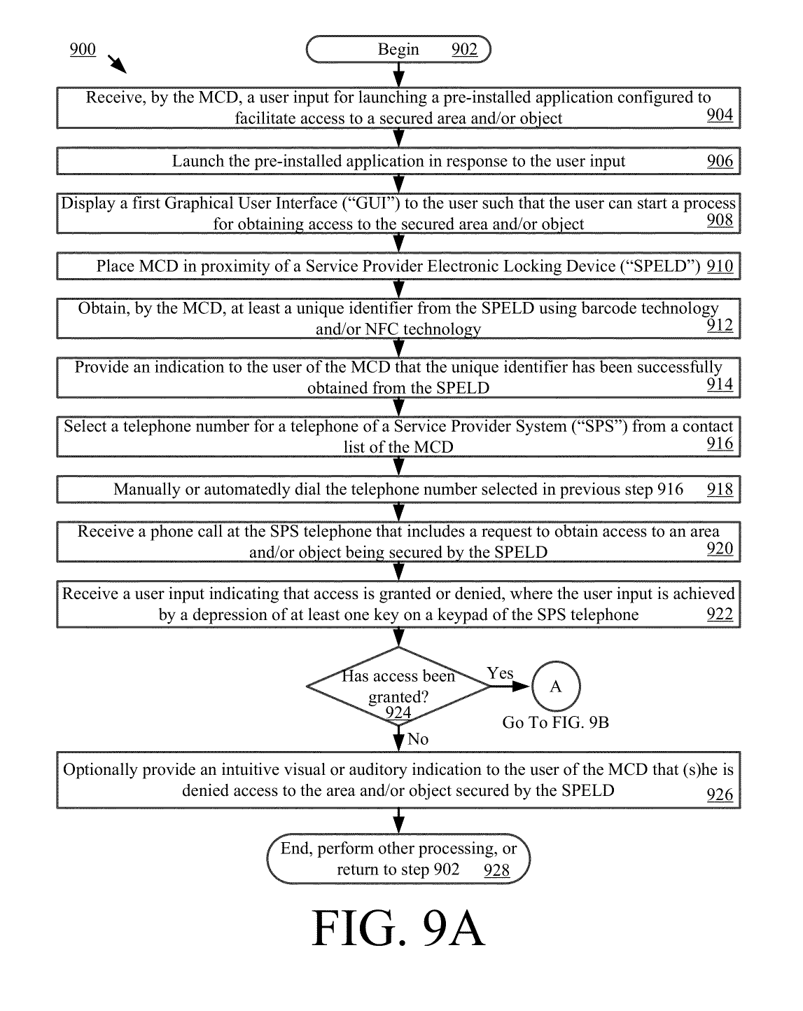

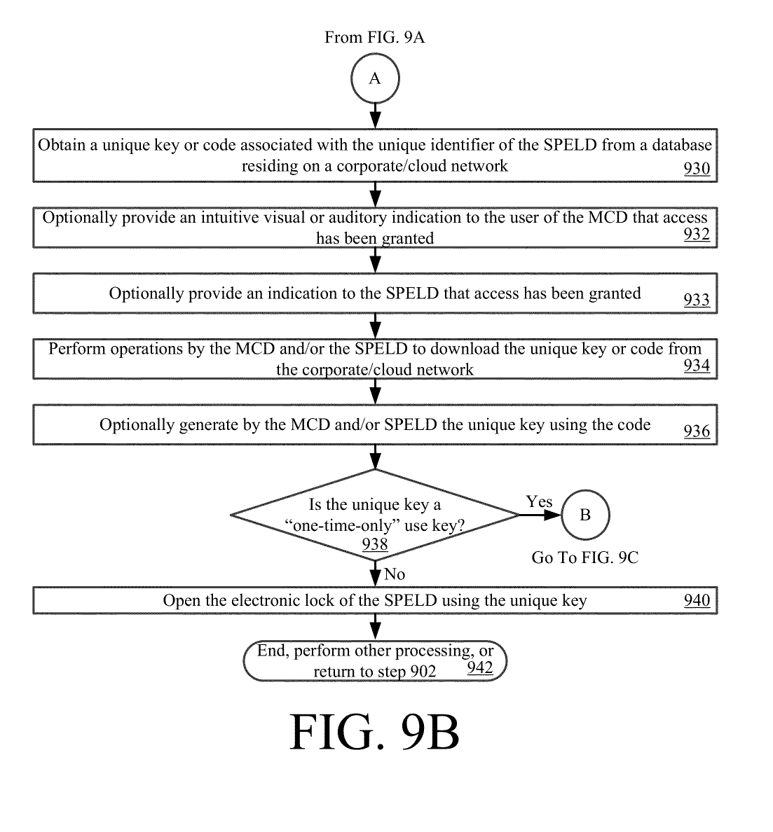

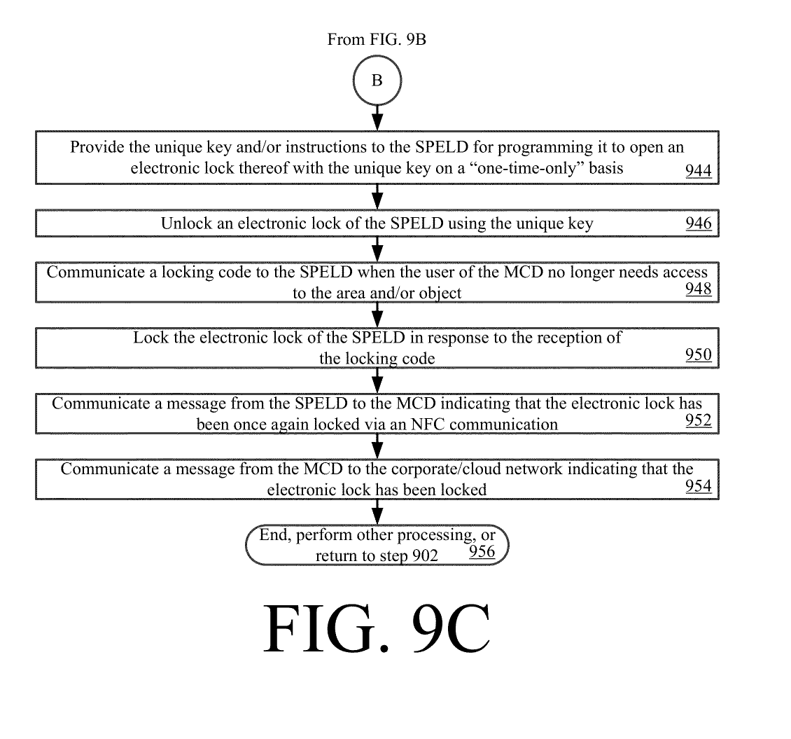

An exemplary method 900 employed by system 800 for unlocking and locking an electronic lock mechanism (e.g., electronic lock mechanism 214 of FIG. 2) is provided in FIGS. 9A-9C. As shown in FIG. 9A, the method 900 begins with step 902 and continues with step 904. Step 904 involves receiving by an MCD (e.g., MCD 104 of FIG. 8) a user input for launching a pre-installed application and/or add-on application configured to facilitate access to a secured area and/or object. In response to the user input, step 906 is performed where the pre-installed application and/or add-on application is launched. Thereafter in step 908, a first GUI is presented on a display screen (e.g., display 328 of FIG. 3) such that the user of the MCD can start a process for obtaining access to the secured area and/or object. The user then places the MCD in proximity of an SPELD (e.g., SPELD 102 of FIG. 8). Consequently, at least a unique identifier of the SPELD is obtained by the MCD via barcode technology or NFC technology. Once the unique identifier has been retrieved from the SPELD, an indication is presented to the user of the MCD indicating that the unique identifier has been successfully obtained thereby, as shown by step 914.

In a next step 916, a telephone number for a telephone (e.g., telephone 802 of FIG. 8) of an SPS (e.g., SPS 818 of FIG. 8) is selected from a contact list of the MCD. This selection can be a manual selection by the user of the MCD or an automated selection by the MCD. The selected number is then dialed manually by the user of the MCD or automatedly by the MCD in step 918. In turn, an automated phone call is received at the SPS telephone, as shown by step 920. The automated phone call includes a request to obtain access to an area and/or an object being protected by the SPELD. The user of the SPS telephone responds to the request in step 922. In this regard, the SPS telephone receives a user input indicating that access is granted or denied. The user input can be achieved by a depression of at least one key on a keypad of the SPS telephone. Alternatively or additionally, the SPS telephone can receive in step 922 a user input indicating a key or code that can be used to unlock an electronic locking mechanism of the SPELD. In this scenario, method 900 can be absent of the steps 924-934.

A determination is then made in step 924 as to whether access has been granted or denied. If access has been denied [924:N0], then method 900 continues with an optional step 926. In optional step 926, an intuitive visual or auditory indication is provided to the user of the MCD indicating that his/her access request has been denied. Subsequently, step 928 is performed where the method 900 ends, other processing is performed, or method 900 returns to step 902.

If access has been granted [924:YES], then method 900 continues with step 930 of FIG. 9B. As shown in FIG. 9B, step 930 involves obtaining a unique key or code associated with the unique identifier of the SPELD from a database (e.g., database 804 of FIG. 8) residing on a corporate/cloud network (e.g., corporate/cloud network 806 of FIG. 8). In a next optional step 932, an intuitive visual or auditory indication is provided to the user of the MCD indicating that his/her access request has been granted. Also, in optional step 933, an indication is provided to the SPELD that access has been granted. Operations are then performed in step 934 by the MCD and/or the SPELD to download the unique key or code from the corporate/cloud network. If the code is downloaded, then the MCD and/or SPELD generate the unique key using the downloaded code, as shown by optional step 936.

If the unique key is not a “one-time-only” use key [938:N0], then operations are performed by the MCD and/or SPELD to open an electronic lock using the unique key. Such operations can include: communicating the unique key from the MCD to the SPELD using NFC technology, if it was not downloaded to the SPELD in previous step 934 or generated by the SPELD in previous step 936; optionally comparing the unique key received by the SPELD with a unique key stored in a memory of the SPELD; and opening the electronic lock using the unique key. The electronic lock can be unlocked based on results of said comparison.

If the unique key is a “one-time-only” use key [938:YES], then steps 944-956 of FIG. 9C are performed. Step 944 involves providing instructions to the SPELD for programming it to open the electronic lock thereof with the unique key on a “one-time-only” basis. If the unique key was not downloaded to the SPELD in previous step 934 or generated by the SPELD in previous step 936, then the unique key is provided to the SPELD in step 944. In turn, the electronic lock is unlocked by the SPELD using the unique key, as shown by step 946. When the user of the MCD no longer needs access to the area and/or object, step 948 is performed where a locking code is communicated to the SPELD. Accordingly, the electronic lock is locked in step 950 by the SPELD using the locking code. Thereafter, messages can be sent from the SPELD to the MCD, SPS telephone and/or corporate/cloud network indicating that the electronic lock has been re-locked, as shown by steps 952, 954. The messages can include, but are not limited to, voice messages and/or text messages. The message can also be pre-recorded messages. Subsequently, step 956 is performed where the method 900 ends, other processing is performed, or the method 900 returns to step 902.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for obtaining access to an area or an object secured by an electronic locking device, comprising:
obtaining, by a mobile communication device, a unique identifier associated with the electronic locking device via a first short range communication;
communicating the unique identifier from the mobile communication device to a remote communication device via a network connection;
receiving at least one symbol associated with the unique identifier that facilitates unlocking of the electronic locking device from the remote communication device via the network connection; and
causing the electronic locking device to be unlocked by communicating a key from the mobile communication device to the electronic locking device via a second short range communication.

2. The method according to claim 1, wherein the first short range communication comprises a near field communication or a barcode communication.

3. The method according to claim 1, wherein the second short range communication comprises a near field communication.

4. The method according to claim 1, wherein at least one of the mobile communication device and the remote communication device comprises a smartphone.

5. The method according to claim 1, wherein the network connection is a secure network connection.

6. The method according to claim 1, wherein the symbol comprises the key.

7. The method according to claim 1, further comprising generating, by the mobile communication device, the key using the symbol received from the remote communication device.

8. The method according to claim 1, further comprising:
communicating instructions from the mobile communication device to the electronic locking device via the second short range communication;
wherein the instructions are configured to cause the key to be used only once during a defined period of time to unlock the electronic locking device.

9. The method according to claim 1, further comprising communicating a locking code from the mobile communication device to the electronic locking device via a third short range communication, the locking code configured to cause the locking of the electronic locking device.

10. The method according to claim 9, further comprising receiving a message from the electronic locking device via a fourth short range communication indicating that the electronic locking device has been locked.

11. The method according to claim 10, further comprising forwarding the message from the mobile communication device to the remote communication device via the network connection.

12. A mobile communication device, comprising:
at least one electronic circuit, configured to:
obtain a unique identifier from an electronic locking device via a first short range communication;
communicate the unique identifier to a remote communication device via a network connection;
receive at least one symbol associated with the unique identifier that facilitates unlocking of the electronic locking device from the remote communication device via the network connection; and
communicate a key to the electronic locking device via a second short range communication for causing the electronic locking device to be unlocked.

13. A method for obtaining access to an area or an object secured by an electronic locking device, comprising:
obtaining, by a mobile communication device, a unique identifier associated with the electronic locking device via a first short range communication;
communicating the unique identifier and authentication information from the mobile communication device to a cloud network;
performing operations by the cloud network to authenticate a user of the mobile communication device using the authentication information; and
communicating an unlocking command from the cloud network to the electronic locking device exclusively when the user is authenticated.

14. The method according to claim 13, wherein the first short range communication is a near field communication or a barcode communication.

15. The method according to claim 13, further comprising communicating a locking code from the mobile communication device to the electronic locking device via a second short range communication, the locking code configured to cause the locking of the electronic locking device.

16. The method according to claim 15, further comprising communicating a message from the electronic locking device to the cloud network indicating that the electronic locking device has been locked.

17. A method for obtaining access to an area or an object secured by an electronic locking device, comprising:
receiving, by a mobile communication device, a unique identifier associated with the electronic locking device via a first short range communication;
placing an automated call to a remote telephone in response to a reception of the unique identifier;
receiving a code for unlocking the electronic locking device from the remote telephone; and
causing the electronic locking device to be unlocked by communicating the code from the mobile communication device to the electronic locking device via a second short range communication.

18. The method according to claim 17, wherein the first short range communication is a near field communication or a barcode communication.

19. The method according to claim 17, wherein the second short range communication is a near field communication.

20. The method according to claim 17, further comprising communicating instructions from the mobile communication device to the electronic locking device via the second short range communication, wherein the instructions are configured to cause the key to be used only once during a defined period of time to unlock the electronic locking device.
